(19) United States
(12) Patent Application Publication
(10) Pub. No.: US 2009/0214725 A1
(43) Pub. Date: Aug. 27, 2009

(54) Continuous Processing of Animal-Source Food Product

(75) Inventors: Aaron Kelly Ormond, Hanford, CA (US); Cesar Alfonso Montano, Hanford, CA (US); Nicholas Del Hofeldt, Pocatello, ID (US)

Correspondence Address: FENWICK & WEST LLP, SILICON VALLEY CENTER, 801 CALIFORNIA STREET, MOUNTAIN VIEW, CA, 94041, US

(73) Assignee: GLOBAL FOOD TECHNOLOGIES, Hanford, CA (US)

(21) Appl. No.: 12/035,622

(22) Filed: Feb. 22, 2008

(51) Int. Cl. A23B 4/14; A23B 4/015

(52) U.S. Cl. 426/248; 426/303; 426/304

(57) ABSTRACT

Methods and apparatus for processing seafood, poultry, and other animal products combines UV-treated water, antimicrobial ice, antimicrobial dip in ozonated water, spray washing apparatus, and individual unit packaging to reduce microbial flora on animal food products and promote extended shelf life.

### RELATED APPLICATION

The subject matter of this application relates to the subject matter of application Ser. No. 12/035,589, entitled “Batch Processing of Animal-Source Food Product,” filed on Feb. 22, 2008, which subject matter is incorporated herein in the entirety by this reference thereto.

### FIELD OF INVENTION

This invention relates to equipment and methods for processing seafood, poultry, and other animal-source food products to reduce microbial flora on the product and promote extension of shelf life.

### BACKGROUND OF INVENTION

Seafood, poultry, and other meat products are considered at-risk foods for carrying food-borne pathogens and other spoilage microorganisms. Due to the high volume processing and the ubiquitous nature of microbes, they are often present in the end consumer food supply and pose a significant health risk to the consumer. Product is often transported and sold fresh, without ever undergoing a freeze process, causing these items to have the highest risk for harboring food-borne pathogens. However, due to the inherent properties of some microorganisms, such as Listeria, frozen products are not without risk and additional control measures in the processing and packaging phases of both fresh and frozen production is warranted.

Ozone is an allotropic form of the element oxygen but in pure form is unstable and usually only minute amounts are present in nature due to its extremely short lifetime (half-life in water is about 20 min.). Ozone is the most chemically active form of oxygen as an oxidizing agent. Ozone may be produced artificially, for example, by passing dry oxygen between two electrodes connected to an alternating high voltage source. Ozone is used commercially for various applications such as a disinfectant and decontaminant for air and water, as a bleaching agent for waxes, oils, and other organic compounds, and as an anti-microbial agent in food processing. Ozone as a reactive oxidizing agent has an oxidizing potential of 2.07 compared with the hydrogen peroxide oxidizing potential of 1.77 and the chlorine gas oxidizing potential of 1.36. Due to this high oxidizing potential, ozone is considered to be an excellent disinfectant, in particular for water treatment.

Short-wave ultraviolet (UV) radiation (i.e., wavelength of 254 nm) can reduce the microbial activity dramatically in air and on hard surfaces that are free from food residues, and can eliminate or significantly reduce pathogens from potable water. UV irradiation at germicidal wavelengths (230-280 nm) causes adjacent thymine molecules on DNA to dimerize, and if enough of these defects accumulate on a microorganism's DNA its replication is inhibited, thereby rendering it harmless (even though the organism may not be killed outright). UV irradiation may thus serve as an effective viricide and bactericide when used appropriately.

### SUMMARY OF THE INVENTION

Ultraviolet (UV) irradiation and antimicrobial constituents in processing water and ice are combined in a system and method for processing animal-source food products to reduce harmful microbial flora. Water used in the process, to make ice and to dip and wash the product, is irradiated with UV at germicide wavelengths. In addition, a peroxygen component such as peracetic acid is included with irradiated water in the formation of ice used in packaging the food product. Also, irradiated water is chilled and ozonated to provide immersion liquid in which the food product is initially dip-washed. Thereafter, the food product is subjected to one or more pressurized spray washes with the UV-irradiated water containing the peroxygen component, and then air-dried prior to final packaging in frozen or fresh-iced form for retail distribution.

### BRIEF DESCRIPTION OF THE DRAWINGS

FIG. 1 is a plan view of a system for processing animal food products such as fish, poultry, or meat; and

FIG. 2 is a flowchart illustrating an embodiment of the processing stages in accordance with the present invention.

### DESCRIPTION OF THE INVENTION

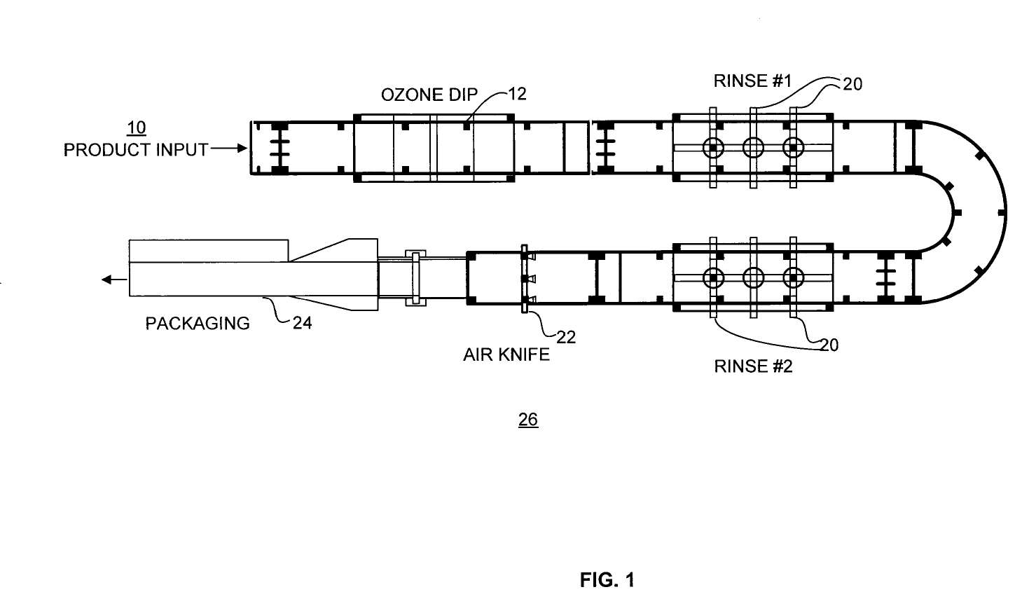

Referring now to the plan view of FIG. 1, there is shown one embodiment of the food processing system in accordance with the present invention. Animal-source food products such as fish fillets, fowl parts, beef steaks, and the like, are initially processed (not shown) into unit portions for entry 10 into the food processing apparatus of the present invention. The unit portions are initially dipped 12 through a chilled solution of ozonated water. Thereafter, the dipped and initially de-contaminated unit portions are conveyed through a series of spray bars 20 that deliver high velocity spray droplets from a pressurized source of a solution of a peroxygen compound in water, as later described herein.

Sprayed unit portions are then conveyed through a drying station 22 at which filtered and purified air is delivered by an ‘air knife’ at high velocity over the surfaces of the unit portions in order to remove excess antimicrobial solution clinging to the surfaces. Thereafter, the dried unit portions are conveyed to the packaging station for freezing or fresh-packed, film-wrapped processing in preparation for retail distribution.

The environment 26 within which the unit portions progress through the processing equipment is maintained in sanitized condition using HEPA filters through which approximately 30-40% of the internal air volume is exchanged per hour, at temperatures not exceeding about 41° Fahrenheit. That is, air is exhausted and replaced by outside air that is filtered before entering the environment 26. Supporting equipment such as chillers and ozone generators and chemical injectors and air-processing apparatus (not shown) is housed externally to the processing environment 26.

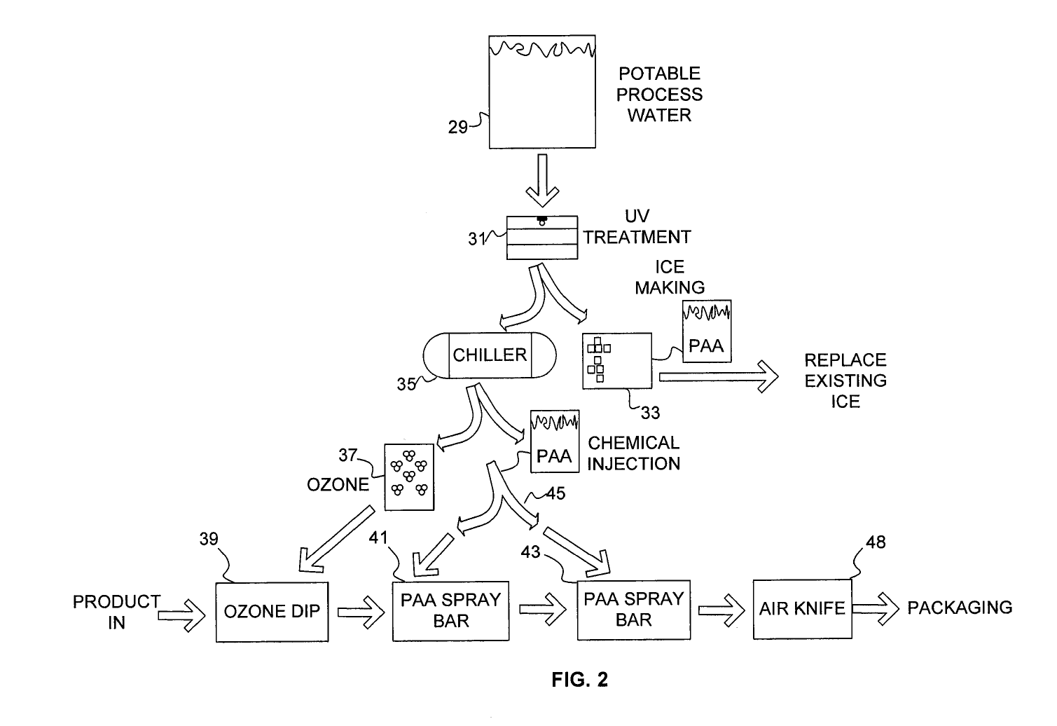

More specifically, and with reference to the flowchart of FIG. 2, there is shown a supply 29 of potable water that will be used in processing animal food products in accordance with the present invention. Such supply 29 is ideally free of heavy metals, organic contaminants, and the like, and may be filtered and otherwise pre-processed to assure high quality supply.

Water from supply 29 is treated 31 with ultraviolet at wavelengths within the germicidal range (i.e., approximately 230-280 nm) to provide sterilized water for formation of ice 33 and for chilling 35 to serve as dipping and spray-washing water.

The ice formation 33 incorporates a peroxygen component such as peracetic acid at a concentration in the range from about 50 to about 150 ppm. This ice provides a continuous supply of the peroxygen component to the food product as packaged or as otherwise in contact with the ice as it melts, for example, during shipment to a facility at which processes of the present invention are performed.

The chilled water is aerated 37 with ozone to provide chilled, disinfectant water for the initial dip washing 39 of product. Thereafter, the disinfected and chilled product is pressure-sprayed 41, 43 one or more times with chilled water 45 that also incorporates a peroxygen component such as peracetic acid (PAA) in a concentration of about 50 to 150 ppm. Of course, successive stages of spray washing 41, 43 may be accomplished with chilled water having different concentrations, different peroxygen components, and different spray parameters for enhanced disinfection of the processed product. For example, the initial spray washing 41 may be performed with a solution of about 120-150 ppm PAA from an elevation of about six inches height above the product. A successive spray washing 43 may be performed with a solution of about 60-80 ppm PAA from an elevation of about 10 inches height above the product.

After the stages of spray washing 41, 43, the disinfected product is air dried 48 using filtered air delivered at high velocity to the product in order to remove excess water and debris adhering to the surface of the product. The product is then packaged, for example, by freezing or by packing in ice 33 containing a peroxygen component for retail distribution.

It is believed that the integrity of the plasma or cytoplasmic membranes of eukaryotic and prokaryotic cells of microbial contaminants is essential for cell viability, and that organic solvents, such as a peroxygen compound, disrupt the hydrophobic bonds between the fatty acids of the lipid bilayers and dissolve the membranes. However, less harsh conditions, such as altering the pH or temperature of the environment can kill cells due to their effects on membrane protein structure. Because protein secondary, tertiary, and quaternary structures are highly dependent upon many non-covalent but highly specific ionic, hydrogen, and hydrophobic bonds between amino acids, agents that disrupt these bonds and denature the membrane proteins can be lethal to the microbial contaminants. For example, acidic pH, produced by the addition of a peroxygen compound, protonates amino acids with negatively charged R groups, like aspartate and glutamate. If an ionic bond between an aspartate residue and a positively charged amino acid like lysine is essential for protein structure, this bonding will be disrupted at low pH, and the protein will not function. Hydrogen bonds are similarly disrupted by changes in pH. Therefore, denaturation in accordance with the processes of the present invention essentially destroys the cell structure of the microbial contaminants through the continued manipulations of the cell environment.

Individual sealed packaging units of unfrozen processed protein products are regulated by FDA guidelines to provide a packaging film with specified oxygen transmission rates. This allows for diffusion of oxygen through the packaging film to prevent the formation of anaerobic conditions leading to a favorable environment for the proliferation of dangerous pathogens such as Clostridium botulinum. Packaging film of this type promotes oxygen transfer at a rate of approximately 0-10,000 cc/m²/24 hours in ambient pressure at a temperature of 70° F. Thus, processed and frozen animal-source protein products are vacuum-packed in such packaging films and show favorable sensory qualities and extended shelf life. Also, the probability for cross contamination of products due to the volume of product traveling through the processing facility and the ubiquitous nature of microorganisms is significantly diminished in accordance with the present invention, and containment in individual packaging after undergoing the microbial reduction processing of the present invention mitigates risk of cross contamination from contact with food-contacting surfaces and/or other contaminated products.

In accordance with the present invention, it is believed that utilizing UV pre-treated process water 31, and utilizing two process-water systems (i.e., one containing an antimicrobial constituent at defined concentrations 45, and the other an ozonated water supply at prescribed concentrations 37), and storing product between harvesting and processing on ice 33 containing an antimicrobial constituent, and submerging product in dip tank 39 containing antimicrobial constituent or ozonated water, and a pressure spray process 41, 43 all significantly reduce microbial loads on seafood, poultry, and other meat products. This is because processing according to the present invention maintains low core temperature of the product, corrupts bacterial genetic material by creation of thymine dimers, disrupts bonding properties and disrupts bacterial membranes by oxidation mechanisms.

Ideally in accordance with the present invention, seafood, poultry, and other meat products are maintained on antimicrobial ice 33 during transport from harvest to the processing stages. All process water in the present invention that comes into contact with animal food product (including water used to create antimicrobial ice 33) is exposed to UV treatment 31, and is either used along with an antimicrobial constituent or undergoes ozonation 37 prior to coming into contact with product. Product emerging from the final stage of processing is conveyed into a separate controlled environment (not shown), with filtered air and ambient temperature reduced below 5 degrees Celsius where the product is loaded onto packaging line for individual portion packaging.

In the course of processing animal food products in accordance with the embodiment of the present invention described herein, the ambient temperature in which the processing is performed directly correlates with microbial growth and hence is a parameter that is controlled in the operating environment of the food processing area to within the range between 34-38 degrees Fahrenheit in order to reduce the growth rates of most mesophilic organisms. Also HEPA-filtered air is exchanged throughout the processing environment at a rate of about 10-40% per hour. That is, air is exhausted and replaced by outside air that is filtered before entering the environment 26.

Product being processed is transported by conveyor through dip tank 39 containing the chilled and ozonated water at a temperature between 35-41 Fahrenheit and containing ozone at a concentration in the range of about 0.1-1.5 ppm at point of contact with product. The rate of conveyance and the length of the dip tank are determined to provide immersion of product for about 1-60 seconds. Exposure to highly oxidative ozone molecules contained in the process water destroys microorganisms by reacting with oxidizable cellular components, particularly those containing double bonds, sulfhydryl groups, and phenolic rings. Therefore, membrane phospholipids, intracellular enzymes, and genomic material react with the ozone to cause cell damage and death of the microorganisms.

From the dip wash 39, product is transported via conveyor beneath one or more successive spray apparatus 41, 43 utilizing process water 45 containing an antimicrobial peroxygen component such as peroxy acid at concentration in the range of about 50-150 ppm.
The spray apparatus with associated nozzles are oriented approximately 3-10 inches above the product moving on the conveyor. Process water 45 is supplied to the spray apparatus at about 100 gallons per minute at a pressure of about 30 psi to create a spray pattern and droplet size of process water that effectively removes surface debris and penetrates the product while being conveyed at rate of about 300 cm/min. In one embodiment of the present invention, the spray apparatus is configured to supply droplets sized within the range from about 100 volume median diameter (vmd) to about 5000 vmd. All spray apparatus may receive the same process water 45 at the same or various pressures and flow rates, water temperatures, and antimicrobial concentrations to remove a quantifiable portion of microbial flora present on the product as well as to remove debris. The rate of conveyance of product determines dwell time beneath the spray apparatus and exposure time to process water. The pressure at which process water is delivered to the spray apparatus also determines the impulse force of impact of spray droplets on the product. After spray processing 41, 43, the product is conveyed through an air-drying station 48 that delivers an air-flow rate of about 3 cubic feet per minute per inch of width of conveyor to sweep the surface of the product to remove excess fluids prior to packaging, as previously described herein.
Therefore, the apparatus and methods of the present invention process animal-source food products to significantly reduce microbial contaminants and thereby promote longer shelf life during retail distribution.

What is claimed is:

1. A method for processing animal source food products for retail distribution, comprising:
immersing the unit portions in a liquid water solution at reduced temperature including an antimicrobial agent;
spraying the unit portions with a water solution at reduced temperature including an antimicrobial agent;
substantially drying excess water solution from surfaces of the unit portions; and
packaging the unit portions for distribution.

2. The method according to claim 1 including irradiating water for the water solutions with ultraviolet energy at effectively germicidal wavelengths.

3. The method according to claim 2 in which irradiated water is combined with the antimicrobial agent at concentrations of about 50 to about 150 ppm.

4. The method according to claim 3 in which the antimicrobial agent is a peroxygen compound.

5. The method according to claim 1 in which the water solution includes ozonated water.

6. The method according to claim 3 in which the antimicrobial agent includes peracetic acid.

7. The method according to claim 3 in which the temperatures of the water solutions are not greater than about 41° F.

8. The method according to claim 1 in which spraying includes impacting the unit portions with droplets of the water solution at effectively sufficient velocity and flow rate to remove surface debris and to coat the unit portions.

9. The method according to claim 8 including a plural number of sprayings prior to substantially drying excess water solutions from surfaces of the unit portions.

10. The method of claim 2 including forming ice of the irradiated water; and
packaging includes packing the ice about the unit portions.

11. The method of claim 10 including adding an antimicrobial agent to the irradiated water used to form the ice.

12. The method of claim 10 in which processing of the animal source includes packing the ice about the animal source prior to formation of the unit portions.

13. The method of claim 11 in which processing the animal source includes packing the ice about the animal source prior to formation of the unit portions.

14. The method according to claim 8 in which droplet sizes are in the range from about 100 vmd (volume median diameter) to about 5000 vmd.

15. The method according to claim 1 in which immersion of the unit portions is for an interval in the range from about 1 to about 60 seconds.

16. The method according to claim 1 in which packaging includes freezing the unit portions.

17. The method according to claim 1 including encapsulating the unit portions within a layer of material capable of transferring oxygen therethrough.

18. The method according to claim 17 in which encapsulation with the layer of material promotes oxygen transfer therethrough at a rate of approximately 0-10000 cc/m²/24 hours in ambient atmospheric pressure at a temperature of 70° F.
